(19) United States
(12) Patent Application Publication
(10) Pub. No.: US 2024/0031862 A1
(43) Pub. Date: Jan. 25, 2024

(54) NETWORK SLICE DYNAMIC CONGESTION CONTROL

(71) Applicant: Telefonaktiebolaget LM Ericsson (publ), Stockholm (SE)

(72) Inventors: Silvia LINS, Indaiatuba (BR); Ricardo da Silva SOUZA, Indaiatuba (BR); Pedro Henrique Gomes Da SILVA, São Paulo (BR)

(21) Appl. No.: 18/029,539

(22) PCT Filed: Oct. 9, 2020
(86) PCT No.: PCT/SE2020/050966

§ 371 Date: Mar. 30, 2023

(51) Int. Cl. H04W 28/02

(52) U.S. Cl. CPC H04W 28/0289

(57) ABSTRACT

A computer-implemented model for dynamic congestion control for network slices is provided. The method includes obtaining a recommendation from a network node for a congestion control process for a plurality of interfaces of a network slice based on at least one condition related to the network slice. Application of the congestion control process addresses the at least one condition related to the network slice. The method further includes applying the congestion control process in a protocol stack for the plurality of interfaces of the network slice.

### TECHNICAL FIELD

The present disclosure relates generally to computer-implemented methods for dynamic congestion control for network slices, and related methods and apparatuses.

### BACKGROUND

Network congestion can happen when network nodes or links are not capable of carrying all traffic generated by transmitting nodes. In the face of network congestion, a congestion control mechanism (also referred to herein as a congestion control process) may be necessary, otherwise the network may collapse and there may be packet losses as well as delays that exponentially increases. A congestion control is a process where sender node as well as relay nodes between sender and receiver control their rate of transmission to achieve an optimal or improved network-wide allocation of resources (e.g., network throughput). In mobile networks such as fourth generation (4G) and fifth generation (5G) networks, transport networks can be highly affected by network congestion since traffic is based on Internet Protocol (IP) flows. While optimizing or improving congestion control in a network, multiple objectives may be pursued to achieve a desired global optimum or improved point of operation. Examples of different objectives and tradeoffs include fairness, aggregated throughput, latency, etc.

### SUMMARY

In various embodiments, operations of a computer-implemented method for dynamic congestion control for network slices is provided. The method includes obtaining a recommendation from a network node for a congestion control process for a plurality of interfaces of a network slice based on at least one condition related to the network slice, wherein application of the congestion control process addresses the at least one condition related to the network slice. The method further includes applying the congestion control process in a protocol stack for the plurality of interfaces of the network slice.

In some embodiments, further operations include extracting the at least one condition related to the network slice, wherein the extracting comprises obtaining the least one condition from at least one of a network slice request and a network knowledge data base.

In some embodiments, further operations include obtaining a network topology of a network slice instance for the network slice request, wherein the network topology comprises a plurality of network functions and a plurality of links between the plurality of network functions assigned to the network slice instance.

In some embodiments, further operations include determining the plurality of interfaces included in the network slice instance.

Corresponding embodiments of inventive concepts for a network node, simulation-to-reality system, computer program products, and computer programs are also provided.

Potential advantages of disclosed embodiments include improved efficiency of 5G networks. For example, different congestion control processes for different network slices may be dynamically implemented. Congestion control process selection may be aware of network slice requirements, and use of congestion control processes may be adaptive over time for newly commissioned network slices. Additionally, as new congestion control processes emerge, such new congestion control processes can be used in a network.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is two diagrams illustrating different network scenarios applying different prioritizations;

FIG. 2 is an exemplary table illustrating a network slice request network slice type (NEST) based on a generic network slice template (GST) standardized by the GSM Association (GSMA);

FIG. 3 is a block diagram of exemplary network interfaces in the user plane between a gNodeB and user plane functions (UPFs);

FIG. 4 is a block diagram of exemplary network interfaces in a control plane between a gNodeB, access and mobility management function (AMF) and session management function (SMF);

FIG. 5 is a diagram illustrating an overview of dynamic congestion control selection in accordance with some embodiments of the present disclosure;

FIG. 6 is a diagram of entities involved in an exemplary embodiment applied to a 5G core network in accordance with some embodiments of the present disclosure;

FIG. 7 is a flow diagram illustrating operations of, and entities involved in, a method in accordance with some embodiments of the present disclosure;

FIG. 8 is a sequence diagram of operations performed in an exemplary embodiment for dynamic congestion control selection in accordance with some embodiments of the present disclosure;

FIG. 9 is a block diagram of a network node in accordance with some embodiments of the present disclosure;

FIG. 10 is a flow chart of operations according to various embodiments of the present disclosure; and

FIG. 11 is a block diagram of a wireless network in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter. The term “user equipment” is used in a non-limiting manner and, as explained below, can refer to any type of communication device. The term “user equipment” herein may be interchangeable and replaced with the term “communication device”. Further, the term “network node” is used in a non-limiting manner and, as explained below, can refer without limitation to any type of core network node in 5G network or any network node in an IP flow-based network.

Different processes for congestion control can address a number of objectives and the best trade-off between the objectives can be considered according to the expected customer experience and current network state (e.g., number of users, operational costs, etc.). Further, the prioritization of the objectives to be pursued can change over time, e.g. when the number of users in the network change. This can involve not only the use of different congestion control mechanisms but also an intelligent system that can dynamically pick and choose different mechanisms according to the network operation.

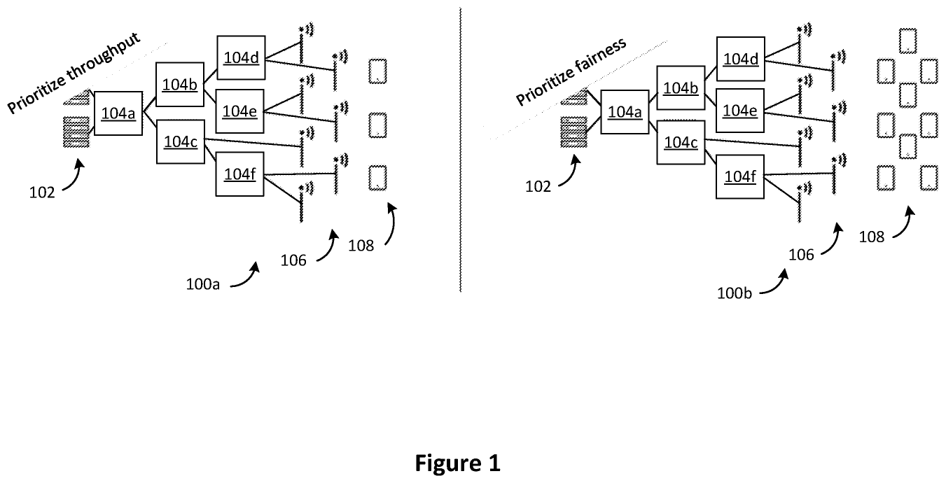

In the 5G Core (5GC), user equipment (UE) (as further defined herein) traffic is associated to a Packet Data Unit (PDU) session that is carried through an IP-based flow between the radio access network (RAN) access point (e.g., a gNodeB) and the User Plane Function (UPF) that is a PDU session anchor, which is the UPF that provides an N6 interface towards a data network (DN). Since this IP-based transport network is under control of the operator, different strategies for flow prioritization may be pursued. For example, if there are few active UEs in the network, the throughput could be prioritized even if this causes some fairness disturbance because it may not affect the UEs' quality of service (QoS). On the other hand, if the network starts to become crowded, one could benefit from a congestion control process that values fairness instead. FIG. 1 is two diagrams 100a, 100b illustrating different network scenarios applying different prioritizations. FIG. 100a illustrates many resources 102 available per UE 108, with throughput through packet switches 104a-104f and base stations 106 to UEs 108 prioritized over fairness without damaging quality of experience (QoE) of UEs 108. FIG. 100b illustrates several UEs 108/traffic, with fairness prioritized through packet switches 104a-104f and base stations 106 to UEs 108 since some UEs 108 may consume all available resources while other UEs 108 could starve.

In the 5GC, each PDU Session is associated with a network slice instance (NSI). A NSI is a logical network that provides specific network capabilities and network characteristics for different UEs and their applications. A network slice involves the access network (RAN), the transport network, the core network (CN) and possibly a cloud network that is part of the communication service provider. Since many links in a network slice are IP flow-based, congestion control mechanisms can have a direct influence in the quality of the network slice, or how well the service level specifications of the network slice will be fulfilled.

A network slice can be formally specified by means of a standardized set of requirements (also referred to herein as specifications) that are used as input to a 5G management system that creates and manages the network slices in the 5G network. The Generic Network Slice Template (GST) or any other proprietary way (e.g., GST is specified by GSMA, and other vertical associations can also have their own slice template specifications) can be used to specify the exact requirements needed for a given network slice that has to be created. A network slice template has a set of application-level attributes that specify the QoS expected by the UE. A goal of a management system can include implementation of a best or improved congestion control mechanism(s) in the links of a 5G network to fulfill the requirements of all network slices being managed in the network.

The following explanation of potential problems with some approaches is a present realization as part of the present disclosure and is not to be construed as previously known by others.

Currently, dynamic changes in the congestion control strategies applied in the 5GC are not implemented and several efficient congestion control processes can be disregarded. A dynamic and cognitive architecture that provides intelligent agents capable of determining a most appropriate or improved combination of different congestion control processes can enhance the efficiency of traffic flow in the 5GC and ease QoS assurance of applications.

During a process of network slice commissioning, network resources and services can be enabled to provide the expected network slice requirements. See e.g., 3GPP TS 28.530, Technical Specification Group Services and System Aspects; Management and orchestration; Concepts, use cases and requirements (Release 16), https://www.3gpp.org/DynaReport/28530.htm. An important piece of the end-to-end network slice solution is all the links between network functions in the user plane, which includes a set of UPFs. Virtual links between all UPFs can be created with standardized tunneling protocol GTP-U. See e.g., GSM Association Official Document NG.116, Generic Network Slice Template, Version 2.0. The traffic in these virtual links is based on UDP and, therefore, may suffer from network congestion. Therefore, selecting the more appropriate or improved congestion control process to run within the (controlled) 5G core network may enable more efficient network slicing.

Currently, an intelligent scheme is not used for solving congestion control in a 5G core network. Moreover, such a scheme would need to be aware of the network slice requirements that are used by users to carry the PDU session. Even if already existing congestion control mechanisms such as Transmission Control Protocol (TCP) Reno version, Cubic version, bottleneck bandwidth and round-trip propagation time (BBR) version, etc. were applied to the network, they could not be dynamically changed as such processes are usually static in their usage on the Internet.

Various embodiments of the present disclosure may provide solutions to these and other potential problems. In some embodiments of the present disclosure, a method is provided using a cognitive layer (in which an Artificial Intelligence (AI)-inspired network of agents are selected in accordance to specified KPIs) to select a best or improved congestion control process to be used in the 5GC interfaces of a given network slice.

As referred to herein, a cognitive layer comprises a combination of semantic information with statistical data from the usage of the available congestion control processes for the selection process. Semantic information can include, without limitation, a semantic description of components and information in the network associated with a congestion control process. In an exemplary embodiment, semantic information includes, without limitation, required information (e.g., channel, UE operating system, UE location); topology or network information that is best for the congestion control process (e.g., datacenter, multipath, or single path); a type of congestion control process (e.g., learning-based (e.g., Monte Carlo-based, supervised learning, unsupervised learning, reinforcement learning, etc.) or rule-based (e.g., loss-based, delay-based, capacity-based, hybrid, etc.); technology or technology information that is best for the congestion control process (e.g., wired or wireless); and priorities (e.g., throughput, fairness, loss reduction, delay reduction, flow completion time (FCT), etc.).

In an exemplary embodiment, semantic information for a specific congestion control process, Timely (see e.g., https://conferences.sigcomm.org/sigcomm/2015/pdf/papers/p537.pdf), includes topology or network information that is best for Timely (e.g., datacenter); the type of congestion control process for Timely (e.g., rule-based (e.g., delay-based)); technology or technology information that is best for Timely (e.g., wired); and priorities for Timely (e.g., throughput and delay reduction).

For the statistical data, unsupervised learning techniques can be used to perform classification of the suitability of the processes based on the data gathered over time.

The combination of these two types of information (i.e. semantic/declarative and usage data) may allow the cognitive layer to take decisions even when there are few usage data available, for example when a new congestion control process is introduced into the system.

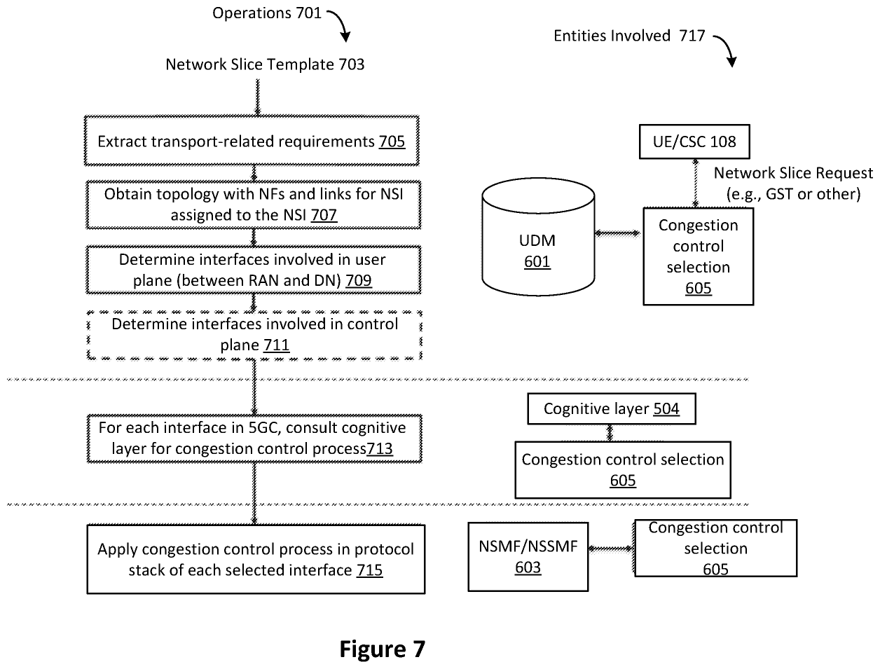

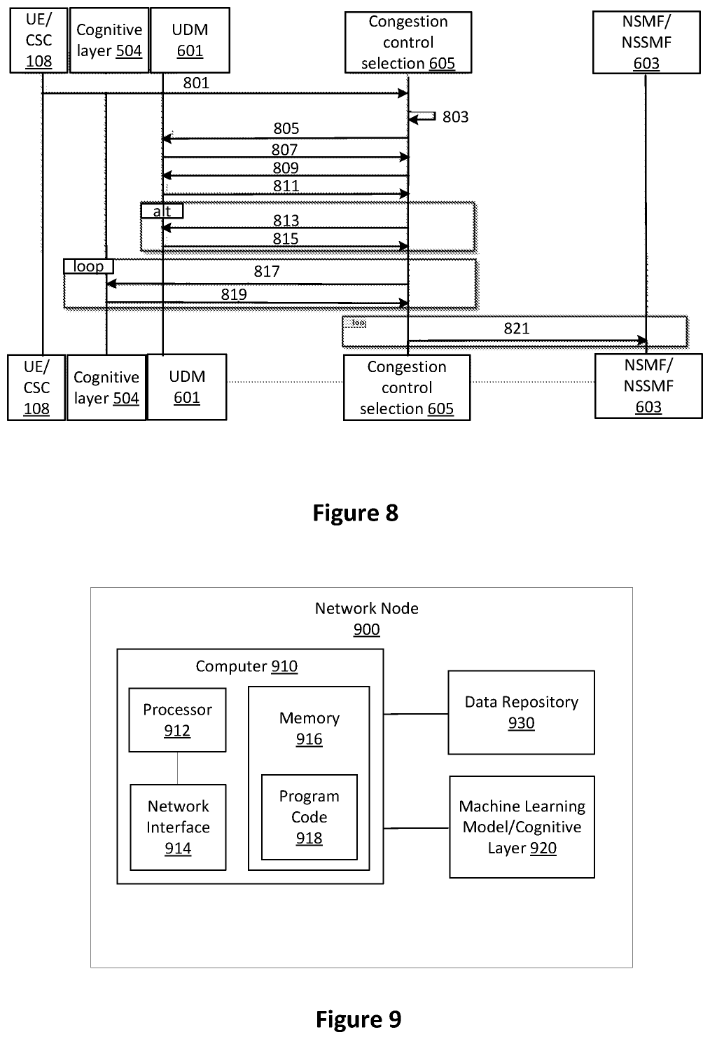

While some embodiments discussed herein are explained in the non-limiting context of a cognitive layer for selecting a congestion control process, the invention is not so limited. Instead, other machine processors may be used, including without limitation, a machine processor can be based only on the unsupervised learning approach. In an exemplary embodiment using a machine processor comprising an unsupervised learning approach, the selection would not take into consideration higher-level declarative knowledge and instead can rely on the insights extracted from the usage data. In an exemplary embodiment using a cognitive layer or an unsupervised learning approach, operational flow from a Network Slice Request until the instantiation of the selected slice follows the operations included in FIGS. 7 and 8 (discussed further herein) with a difference that in an exemplary embodiment using an unsupervised learning approach, instead of the cognitive layer, congestion control selection module 605 can receive and reply to the request directly.

The dynamic congestion control selection in accordance with various embodiments of the present disclosure can be implemented as a virtual network function or part of existing network functions. As a consequence, the method of various embodiments can run in a cloud environment. The method of the present disclosure can be implemented in a cloud environment in a manner similar to exemplary implementations described herein as part of existing network functions.

In some embodiments, since a core network and its network functions are under control of an operator, a cognitive layer can select an agent that implements the best or an improved strategy for a given network scenario. Some of the new machine learning (ML)-based congestion control processes (e.g., reinforcement learning (RL)) can be included in the list of choices, together with traditional TCP congestion control, e.g. Cubic version, BBR version, etc.

In various embodiments, dynamic selection of a congestion control process can be applied to flows that use any type of transport protocols, such as User Datagram Protocol (UDP), Transmission Control Protocol (TCP) or Stream Control Transmission Protocol (SCTP). In the case of TCP and SCTP, a congestion control process can directly use the standardized fields in the header or use non-standardized header options. In case of UDP, a congestion control process can add an extra header on top of UDP with any necessary data or leverage tunneling header such as general packet radio service (GPRS) Tunneling Protocol (GTP-U), which is a choice for user plane interfaces in 5GC.

The method of various embodiments of the present disclosure includes the cognitive layer selecting different protocol stacks according to the current network slices requirements. The network slice specification can be specified by means of standardized templates like the GST from GSMA, or other means provided by the operator or by vertical industry associations. Once the network requirements are specified, the cognitive layer is asked to choose an agent (e.g., ML model) to implement a congestion control process that addresses such demands. The agent can also consider not only the GST specification, but also other relevant information, such as current network status and coexistence with other traffic flows, the network topology involved, etc. Then the selected congestion control process(s) is applied in the protocol stacks for network functions (mostly UPFs) for each interface in the 5G core.

In various embodiments of the present disclosure, since the congestion control is aware of the network slice requirements, the selection of the congestion control process(es) to be applied can be used by the Network Slice Management Function/Network Slice Subnet Management Function (NSMF/NSSMF) during a network slice commissioning phase.

Further, in various embodiments of the present disclosure, for the selection process, the cognitive layer can use a combination of declarative and statistical knowledge. The declarative component includes knowledge encapsulated in the cognitive layer describing the algorithms (e.g. coexistence with other algorithms, what characteristic does it favor—fairness, throughput, etc.). The statistical component includes insights extracted from metrics collected from when the algorithm is running.

Potential advantages provided by various embodiments of the present disclosure may include improving efficiency of 5G core networks. Efficiency improvements may include:

(1) Different congestion control processes for different network slices. The concept of a network slice can implicate isolation of network resources. Since an intelligent agent(s) can choose a congestion control process based on IP flows and is aware of the network slices, different congestion control processes can be applied to different network slices according to optimization or improvement criteria of a network management system.

(2) Network slice requirements-aware congestion control selection. A best or improved intelligent agent(s) can also be deployed for individual network slices to better serve their requirements. A management system can consider not only individual network slices requirements, but also the aggregate of all network slices commissioned to run in the network to take global optimum or improvement decision.

(3) Adaptive use of congestion control processes. A best or improved congestion control process can also be changed over time for newly commissioned network slices.

(4) Evolution with new congestion control processes. As new congestion control processes emerge, especially with ML-based techniques, new intelligent agents can be used in the network.

A dynamic congestion control selection method of various embodiments of the present disclosure may select the most appropriate congestion control process(es) to be used in 5G core interfaces between network functions to fulfill requirements of the network slices associated with the network services used by UEs. The method can include an AI-based cognitive layer. The cognitive layer includes a set of intelligent agents that can optimize high-level KPIs. In some embodiments, inputs to the method include: high-level requirements that are considered as KPIs to the cognitive layer, and knowledge coming from diverse sources. High-level requirements in a 5G system can be associated to the network slice to be provided to the network service and they can be expressed by means of network slice templates. In the 5GC, at least some of the knowledge can be retrieved from a UDM network function. The output of the method includes the selection of an appropriate congestion control process (e.g., a most appropriate congestion control process) to be used by the network functions involved in a given network slice. In terms of the 5G core, if the method is applied to the user plane, the selected congestion control process can be used by the N3 interface, between a gNodeB and a first selected UPF, and by all N9 interfaces between a first selected UPF and a PDU session anchor.

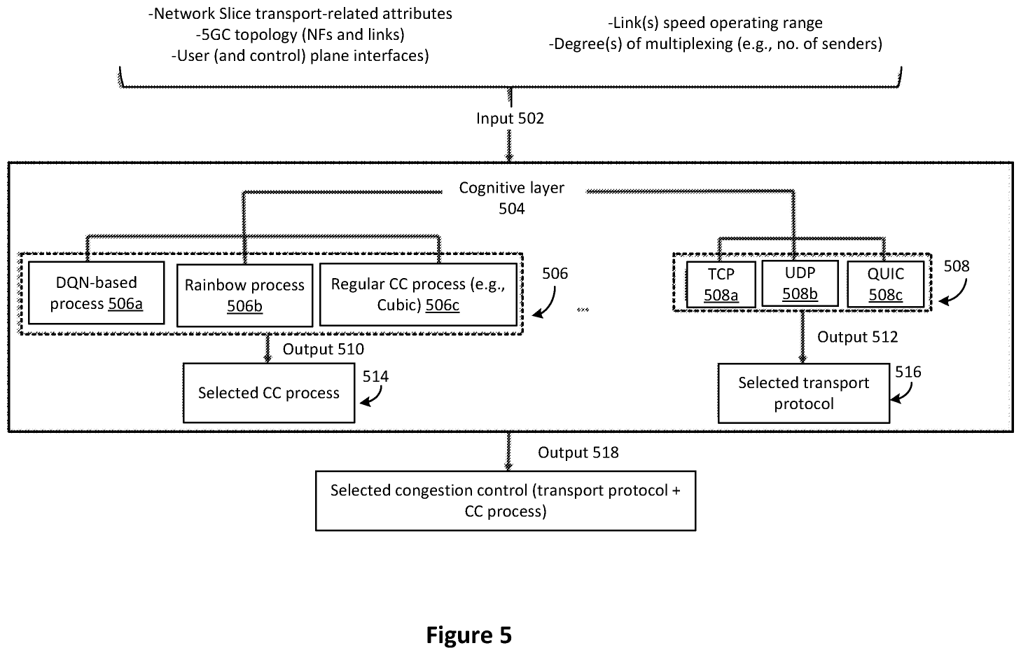

FIG. 5 is a diagram illustrating an overview of dynamic congestion control selection in accordance with some embodiments of the present disclosure. While embodiments discussed herein above are explained in the non-limiting context of a 5G network, the invention is not so limited. Instead, other networks may be used, including without limitation, any IP flow-based network. The exemplary embodiment of FIG. 5 illustrates an overview of the method of various embodiments with respect to, e.g., 5G network functions, interfaces, etc. or any type of existing and future IP flow-based network. Various embodiments of the present disclosure are discussed herein in the context of a 5GC, including richness of data and knowledge commonly found in mobile network core functions, and nodes in the network that can be designed to cope with dynamic changes in the congestion control process used. As a consequence, the method of various embodiments can be applicable to controlled and green-field deployments, e.g. a 5GC.

Still referring to FIG. 5, cognitive layer 504 receives input 502. Input 502 includes, without limitation, network slice transport-related attributes, 5GC topology (e.g., network functions and links), user plane and/or control plane interfaces, link(s) speed operating range, degree(s) of multiplexing (e.g., number of senders), etc. Based on input 502, cognitive layer 504 obtains a dynamic recommendation for a congestion control process 514 for interfaces for a selected transport protocol 516 of a network slice based on at least one condition related to the network slice from input 502. Cognitive layer 504 outputs 518 the selected congestion control process (including the selected transport protocol and the selected congestion control process).

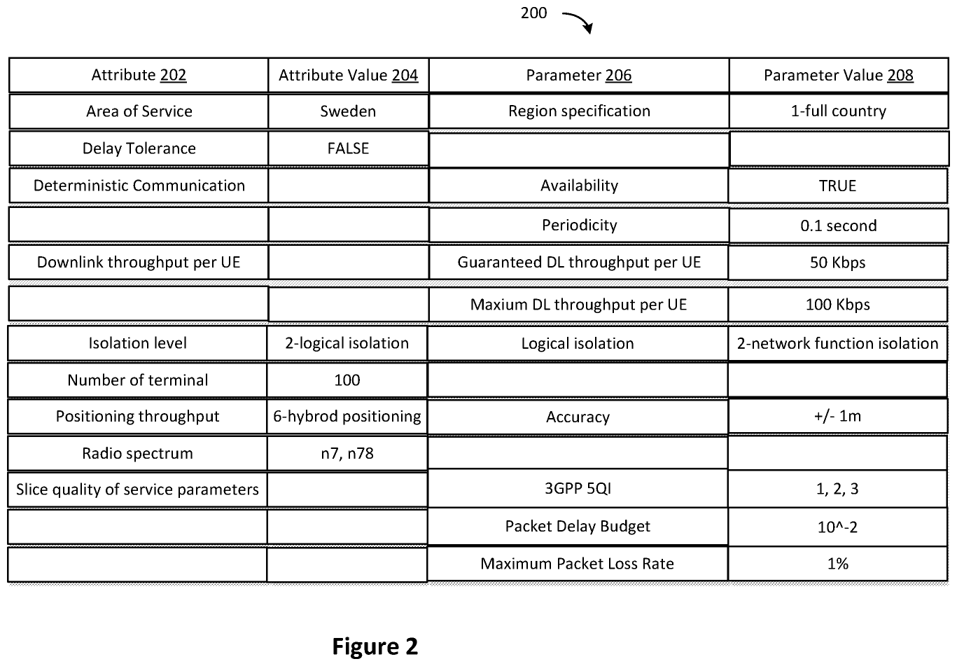

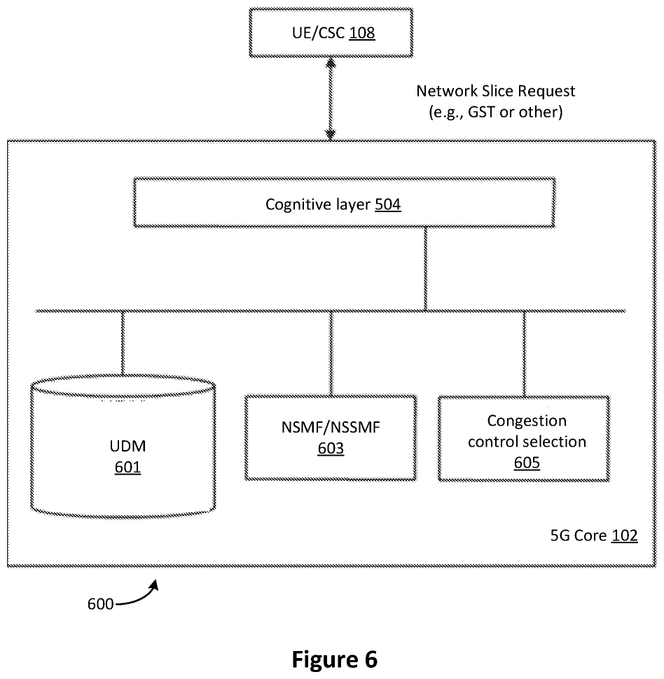

FIG. 6 is a diagram of entities involved in an exemplary embodiment applied to a 5G core network in accordance with some embodiments of the present disclosure. Referring to FIG. 6, UE or any communication service consumer (CSC) device 108 provides as input to cognitive layer 504 a network slice request that includes a list of requirements to be fulfilled by a communication service provider (CSP) that manages a 5G network. While cognitive layer 504 is depicted as a layer in 5G core node 102, the invention is not so limited. Instead, other locations for cognitive layer 504 may be used, including without limitation, in an external network, an external network connected to the Internet, etc. FIG. 2 (described further below) is an exemplary table 200 illustrating a illustrating a network slice request network slice type (NEST) based on a generic network slice template (GST) standardized by the GSM Association (GSMA). See e.g., GSM Association Official Document NG.116, Generic Network Slice Template, Version 3.0. Referring again to FIG. 6, cognitive layer 504 is communicatively connected to UDM 60, NSMF/NSSMF 603, and congestion control selection module 605 to perform operations of various embodiments of the present disclosure (e.g., as described regarding FIG. 5).

Referring again to FIG. 2, table 200 includes attributes 202. In an exemplary embodiment, attributes 202 include delay tolerance, deterministic communication, and slice quality of service parameters which are some non-limiting examples of attributes for the purpose of congestion control process selection. For each attribute 202, table 200 also can include an attribute value 204, a parameter 206 and a parameter value 208.

FIG. 7 is a flow diagram illustrating operations of, and entities involved in, a method in accordance with some embodiments of the present disclosure. Operations 701 of FIG. 7 are summarized below:

From a network slice template 703, operation 705 includes extracting transport-related requirements for a given network slice (e.g., delay tolerance, downlink/uplink throughput, etc.). The requirements can be obtained directly from the network slice request sent by the UE/CSC 108, or it can be obtained from network databases such as a UDM where information related to all network slice instances is stored. The attributes discussed above with respect to the table of FIG. 2 are examples of transport-related requirements that can be considered.

Operation 707 includes obtaining network topology of a network slice instance that has already been (or will be) commissioned for the network slice request. The network topology includes network functions and the (virtual) links between them for the network slice instance assigned the network slice request. The network functions can be part of a user plane or a control plane. The communication between network functions in a 5G core network can follow the service-based architecture (SBA) where representational state transfer (REST)-based operations based on hypertext transfer protocol (HTTP) protocol is used or can follow interface-based architecture where network function communicate directly using different types of transport protocols and tunneling. In some embodiments, interface-based connections between network functions are used for the application of the congestion control method since these interfaces can have more traffic that suffer from network congestion and have a deterministic pair of network functions involved in the communication.

In some embodiments, operation 709 includes determining network interfaces in the user plane that are part of the network slice instance (e.g., between the RAN and a data network). The interfaces in this exemplary embodiment are N3 (between a gNodeB and a first selected UPF) and N9 (between UPFs); and these interfaces use GTP-U tunneling protocol to carry the data payloads.

Optionally or alternatively, in some embodiments, optional operation 711 includes determining the network interfaces in the control plane where a congestion control process may be useful. As discussed further below, this operation is optional and can be considered depending on the evolution and growth of the network control plane of core networks.

In some embodiments, operation 713 includes consulting a cognitive layer for selection of a best or improved congestion control process for each of the selected interfaces in a 5G core network. For operation 713, the network slice requirements extracted in operation 705 may be normalized and transformed into KPIs that can be processed by the cognitive layer. The selection method is performed by the cognitive layer (e.g., AI-inspired processes) that leverage existing declarative and procedural knowledge and machine reasoning technologies.

In some embodiments, operation 715 includes applying the selected congestion control process(es) in the target network functions (found in operation 707). Implementation of the congestion control selection can take place by different locations/entities 717 and at different phases of the lifecycle of the network slice. For example, in some embodiments, the selection can involve the configuration of the network functions during network slice commissioning and/or instantiation phases. See e.g., 3GPP TR 28.801, Technical Specification Group Services and System Aspects; Telecommunication management; Study on management and orchestration of network slicing for next generation network (Release 15), www.3gpp.org/DynaReport/28801.htm. Different congestion control processes can previously be implemented in virtual or physical network interface cards.

Still referring to FIG. 7, entities involved 717 in various embodiments of the present disclosure include, without limitation, UEs/CSC 108 communicating regarding a network slice request (e.g., GST or other) with congestion control selection module 605. Congestion control selection module 605 can communicate with UDM 601 (e.g., in connection with any of operations 705-711). Optional operation 711 can involve either cognitive layer 504 or congestion control selection module 605. Option 715 can involve congestion control selection module 605 communicating with NSMF/NSSMF 603.

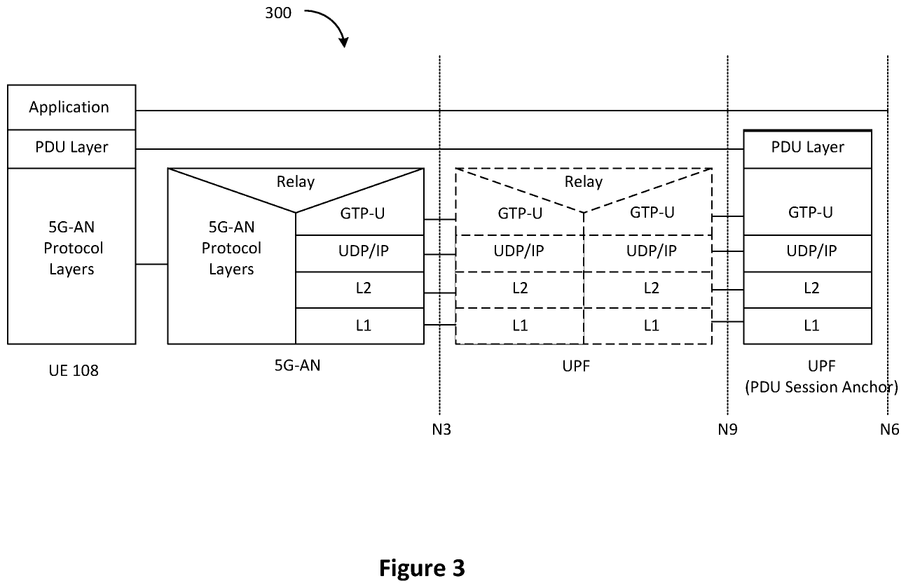

Applicability of an exemplary embodiment of the method of the present disclosure will now be discussed in 5GC user and control planes. The method of various embodiments of the present disclosure can be used for congestion control selection in any part of a 5GC, including control plane and user plane. In some embodiments for the user plane, the selected congestion control process(es) can be used in the GTP-U tunnel established over the interfaces N3 and N9 (see e.g., FIG. 3 showing a block diagram 300 of exemplary network interfaces in the user plane between a gNodeB and user plane functions (UPFs)). This is can be a common scenario where the congestion control selection can be applied as congestion control can be important for the QoS of the 5G slice and the user plane can be where a majority of data flows travel.

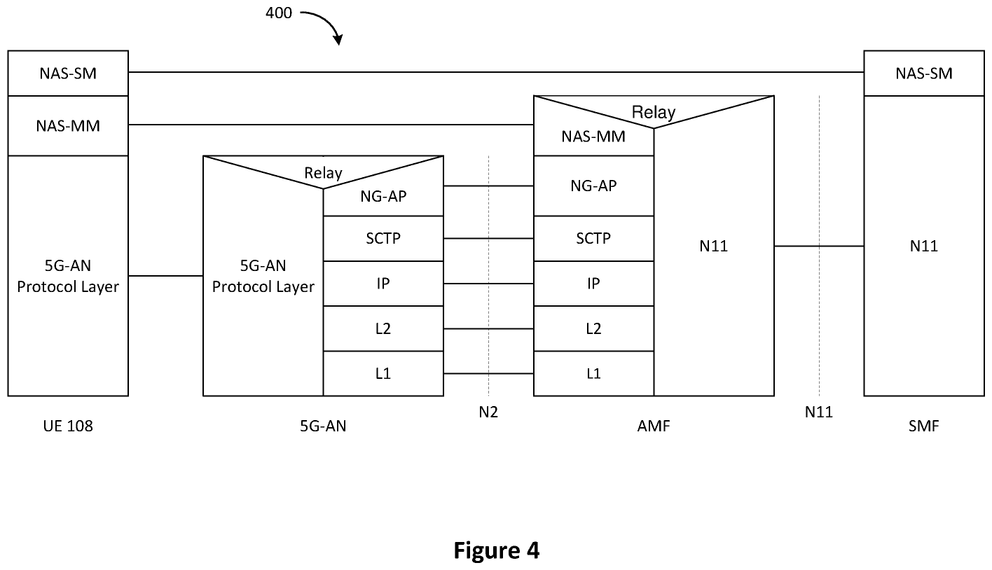

In some embodiments for the control plane, the transport-level protocol of control flows can be more heterogeneous and vary according to the interface. FIG. 4 is a block diagram 400 of exemplary network interfaces in a control plane between a gNodeB, access and mobility management function (AMF) and session management function (SMF). Referring to FIG. 4, interfaces are shown in a control plane that use SCTP. It is noted that while all interfaces may benefit from a better congestion control selection, interoperability could be damaged if a different congestion control process is applied to the network function at either ends of the interfaces. It is further noted that traffic in a control plane may cause less congestion and be less restrictive in terms of QoS requirements.

FIG. 8 is a sequence diagram of operations performed in an exemplary embodiment for dynamic congestion control selection in accordance with some embodiments of the present disclosure.

Referring to FIG. 8, UE/CSC 108 sends 801 to congestion control selection module 605 a network slice request with requirements (e.g., NEST). Responsive to receiving the network slice request, congestion control selection 605, extracts 803 transport-related requirements from the network slice request.

At operation 805, congestion control selection module 605 requests network slice topology, including network functions and links, from UDM 601. Responsive to the request of operation 805, UDM 601 sends 807 the network slice topology to congestion control selection module 605.

At operation 809, congestion control selection module 605 requests from UDM 601 the user plane interfaces used in the network slice. Responsive to the request of operation 809, UDM 601 sends 811 the user plane interfaces information (e.g., end points and links) to congestion control selection module 605.

Alternatively, in some embodiments, operations 813 and 815 can be performed. In operation 813, congestion control selection module 605, requests control plane interfaces used in the network slice. Responsive to the request of operation 813, UDM 601 sends control plane interface information (e.g., end points and links) to congestion control selection module 605.

Operations of 817 and 819 are dynamically repeated (or in other words looped) for each of the selected interfaces. In operation 817, congestion control selection module 605 requests from cognitive layer 504 a congestion control process. Responsive to the request of operation 817, cognitive layer 504 sends a selected congestion control process (or the identity of a selected congestion control process) to congestion control selection module 605.

Still referring to FIG. 8, operation 821 is repeated (or in other words looped) for each of the selected interfaces. In operation 821, congestion control selection module 605 applies the selected congestion control process in NSMF/NSSMF 603.

Various embodiments of the present disclosure include a method to select a best or improved congestion control process for a transport network of network slices based on a set of requirements. The selection can be aided by an AI-based method (e.g. cognitive layer and/or a machine processor) that can select the best or an improved process(es) based on declarative knowledge and/or historical data. The selection can further take into account standardized requirements for network slices that can be expressed by means of templates such as GST from GSMA, or any other expressions created by other vertical industries.

In various embodiments, the method can include six operations, as described with reference to FIGS. 7 and 8, where initially transport-related requirements can be extracted and from a network topology that is part of a network slice where relevant interfaces are found. For interfaces in the user plane, and optionally for interfaces in the control plane, a congestion control process(es) can be applied following the provided recommendation.

In some embodiments, the selection method can be implemented as part of the Network Slice Management Function/Network Slice Subnet Management Function (NSMF/NSSMF) during a network slice commissioning phase.

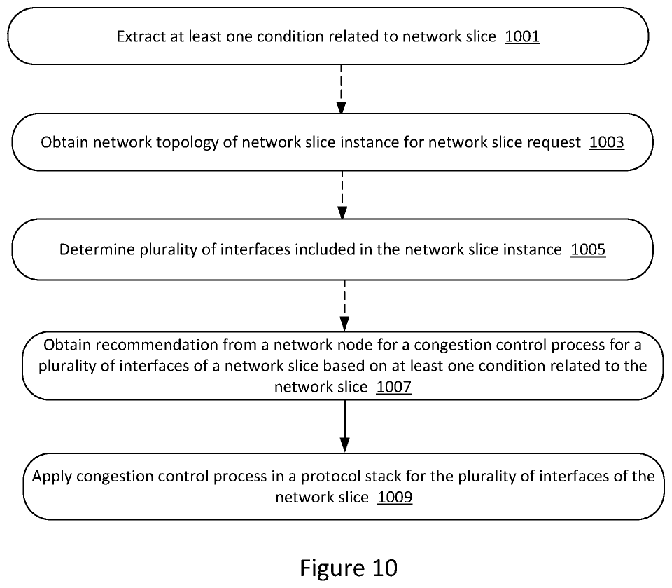

Now that the operations of the various components have been described, operations specific to a network node 900 of a network (implemented using the structure of the block diagram of FIG. 9) for performing a computer-implemented method for dynamic congestion control for network slices will now be discussed with reference to the flow chart of FIG. 10 according to various embodiments of the present disclosure. As shown, network node 900 may include network interface circuitry 914 (also referred to as a network interface) configured to provide communications with other nodes of the network and/or the radio access network RAN. Network node 900 may also include a processing circuitry 912 (also referred to as a processor) coupled to the network interface circuitry, and memory circuitry 916 (also referred to as memory) coupled to the processing circuitry 912. The memory circuitry 916 may include computer readable program code that when executed by the processing circuitry 912 causes the processing circuitry 912 to perform operations. Further, modules may be stored in memory 916, and these modules may provide instructions so that when the instructions of a module are executed by respective computer processing circuitry of machine learning model or cognitive layer 920, processing circuitry of machine learning model or cognitive layer 920 performs respective operations of the flow chart of FIG. 10 according to embodiments disclosed herein.

As discussed herein, operations of the network node 900 may be performed machine learning model or cognitive layer 920 and/or network interface circuitry 914. For example, machine learning model or cognitive layer 920 and/or processor 912 may control network interface circuitry 914 to transmit communications through network interface circuitry 914 to one or more other network nodes and/or to receive communications through network interface circuitry from one or more other network nodes. Each of the operations described in FIG. 10 can be combined and/or omitted in any combination with each other, and it is contemplated that all such combinations fall within the spirit and scope of this disclosure.

Referring to FIG. 10, a computer-implemented method is provided for dynamic congestion control for network slices. The method includes obtaining 1007 a recommendation from a network node for a congestion control process for a plurality of interfaces of a network slice based on at least one condition related to the network slice. Application of the congestion control process addresses the at least one condition related to the network slice. The method further includes applying 1009 the congestion control process in a protocol stack for the plurality of interfaces of the network slice.

In some embodiments, the network node includes at least one of a cognitive layer and a machine learning model. The machine learning model includes an unsupervised machine learning model.

In some embodiments, the cognitive layer includes declarative and statistical knowledge. The declarative knowledge includes knowledge encapsulated in the cognitive layer describing a plurality of congestion control processes and the statistical knowledge includes information extracted from a plurality of metrics of an operating congestion control process from the plurality of congestion control processes.

In some embodiments, the at least one condition related to the network slice includes at least one of a specification of the network slice, a status of the network, a traffic flow in other network slices, and a topology of the network.

In some embodiments, the obtaining (1007) includes processing inputs to the cognitive layer to obtain an output from the cognitive layer. The output includes the recommendation for the congestion control process. The inputs include at least one key performance indicator, KPI, associated with the at least one condition related to the network slice and at least one knowledge information from the network.

In some embodiments, the applying (1009) the congestion control process in a protocol stack for the plurality of interfaces of the network slice includes application of the congestion control process to a traffic flow through the plurality of interfaces using a transport protocol.

In some embodiments, the method further includes extracting (1001) the at least one condition related to the network slice. The extracting includes obtaining the least one condition from at least one of a network slice request and a network knowledge data base.

In some embodiments, the method further includes obtaining (1003) a network topology of a network slice instance for the network slice request. The network topology includes a plurality of network functions and a plurality of links between the plurality of network functions assigned to the network slice instance.

In some embodiments, the method further includes determining (1005) the plurality of interfaces included in the network slice instance.

In some embodiments, the plurality of interfaces includes interfaces in a user plane or in a control plane of the network.

In some embodiments, the extracting (1001) includes normalizing and transforming the at least one condition into the at least one KPI.

In some embodiments, the applying (1009) the congestion control process for a plurality of interfaces of a network slice includes applying the congestion control process in the plurality of network functions.

In some embodiments, the obtaining (1007) includes obtaining subsequent to configuration of the plurality of network functions at least at one of during a network slice commissioning and instantiation phase.

Various operations from the flow chart of FIG. 10 may be optional with respect to some embodiments of a computer-implemented method for dynamic congestion control for network slices and related methods. For example, operations of blocks 1001, 1003 and 1005 of FIG. 10 may be optional.

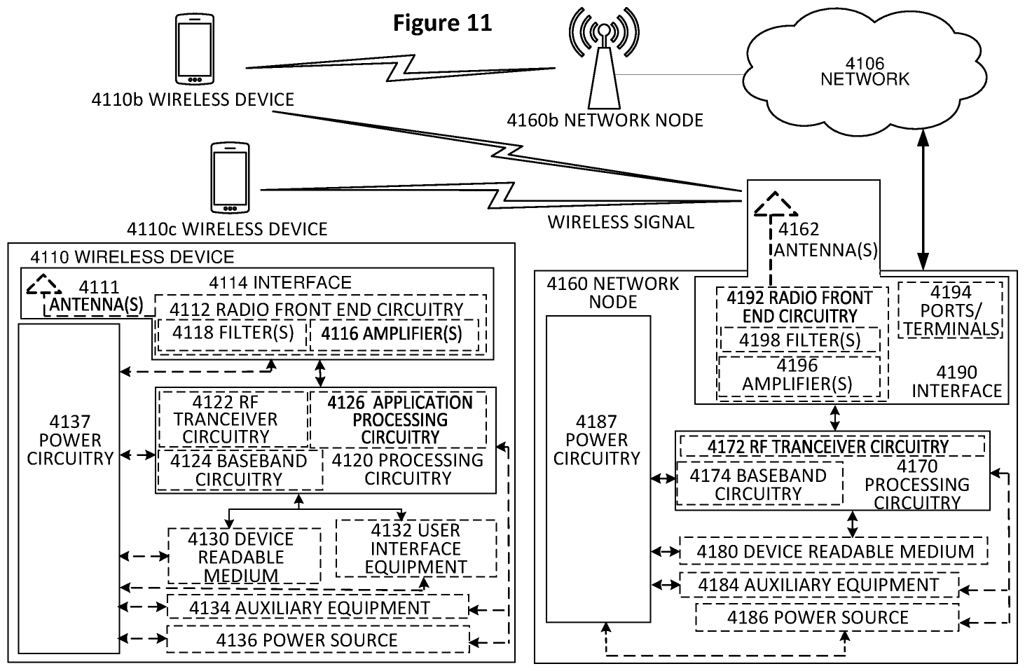

FIG. 11 is a block diagram of a wireless network in accordance with some embodiments.

Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, core nodes, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 11 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4190 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 11 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, user equipment (UE) or communication service consumer (CSC) device refers to a device capable, configured, arranged and/or operable to communicate wirelessly with network nodes and/or other wireless devices. Unless otherwise noted, the term UE may be used interchangeably herein with user equipment, user device, communication device, wireless device (WD), and/or CSC device. Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE as described above may represent the endpoint of a wireless connection, in which case the device may be referred to as a wireless terminal. Furthermore, a UE as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4114 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

Explanations are provided below for various abbreviations/acronyms used in the present disclosure.

### Abbreviation Explanation

5GC 5G Core
UE User Equipment
DN Data Network
UPF User Plane Function
UDP User Datagram Protocol
TCP Transmission Control Protocol
SCTP Stream Control Transmission Protocol
GTP-U GPRS Tunneling Protocol—User plane
PDU Packet Data Unit
RAN Radio Access Network
CN Core Network

References are identified below.
1. 3GPP TS 28.530—Technical Specification Group Services and System Aspects; Management and orchestration; Concepts, use cases and requirements (Release 16)—https://www.3gpp.org/DynaReport/28530.htm
2. GSM Association Official Document NG.116—Generic Network Slice Template, Version 2.0
3. 3GPP TR 28.801—Technical Specification Group Services and System Aspects; Telecommunication management; Study on management and orchestration of network slicing for next generation network (Release 15)—www.3gpp.org/DynaReport/28801.html

1. A computer-implemented method for dynamic congestion control for network slices, the method comprising:
obtaining a recommendation from a network node for a congestion control process for a plurality of interfaces of a network slice based on at least one condition related to the network slice, wherein application of the congestion control process addresses the at least one condition related to the network slice; and
applying the congestion control process in a protocol stack for the plurality of interfaces of the network slice.

2. The method of claim 1, wherein the network node comprises at least one of a cognitive layer and a machine learning model, and wherein the machine learning model comprises an unsupervised machine learning model.

3. The method of claim 2, wherein the cognitive layer comprises declarative and statistical knowledge, wherein the declarative knowledge comprises knowledge encapsulated in the cognitive layer describing a plurality of congestion control processes and wherein the statistical knowledge comprises information extracted from a plurality of metrics of an operating congestion control process from the plurality of congestion control processes.

4. The method of claim 1, wherein the at least one condition related to the network slice comprises at least one of a specification of the network slice, a status of the network, a traffic flow in other network slices, and a topology of the network.

5. The method of claim 2, wherein the obtaining comprises processing inputs to the cognitive layer to obtain an output from the cognitive layer comprising the recommendation for the congestion control process, wherein the inputs comprise at least one key performance indicator, KPI, associated with the at least one condition related to the network slice and at least one knowledge information from the network.

6. The method of claim 1, wherein the applying the congestion control process in a protocol stack for the plurality of interfaces of the network slice comprises application of the congestion control process to a traffic flow through the plurality of interfaces using a transport protocol.

7. The method of claim 1, further comprising:
extracting the at least one condition related to the network slice, wherein the extracting comprises obtaining the least one condition from at least one of a network slice request and a network knowledge database.

8. The method of claim 7, further comprising:
obtaining a network topology of a network slice instance for the network slice request, wherein the network topology comprises a plurality of network functions and a plurality of links between the plurality of network functions assigned to the network slice instance.

9. The method of claim 7, further comprising:
determining the plurality of interfaces included in the network slice instance.

10. The method of claim 9, wherein the plurality of interfaces comprises interfaces in a user plane or in a control plane of the network.

11. The method claim 7, wherein the extracting comprises normalizing and transforming the at least one condition into the at least one KPI.

12. The method of claim 8, wherein the applying the congestion control process for a plurality of interfaces of a network slice comprises applying the congestion control process in the plurality of network functions.

13. The method of claim 8, wherein the obtaining comprises obtaining subsequent to configuration of the plurality of network functions at least at one of during a network slice commissioning and instantiation phase.

14. A network node for dynamic congestion control for network slices, the network node comprising:
at least one processor;
at least one memory connected to the at least one processor and storing program code that is executed by the at least one processor to perform operations comprising:
obtaining a recommendation from the network node for a congestion control process for a plurality of interfaces of a network slice based on at least one condition related to the network slice, wherein application of the congestion control process addresses the at least one condition related to the network slice; and
applying the congestion control process in a protocol stack for the plurality of interfaces of the network slice.

15. The network node of claim 14, wherein the at least one memory connected to the at least one processor and storing program code that is executed by the at least one processor to perform operations of obtaining a recommendation from a network node for a congestion control process for a plurality of interfaces of a network slice based on at least one condition related to the network slice, wherein application of the congestion control process addresses the at least one condition related to the network slice; and
applying the congestion control process in a protocol stack for the plurality of interfaces of the network slice,
wherein the network node comprises at least one of a cognitive layer and a machine learning model, and wherein the machine learning model comprises an unsupervised machine learning model.

16. A network node, for dynamic congestion control for network slices,
the network node adapted to perform operations comprising:
obtaining a recommendation from the network node for a congestion control process for a plurality of interfaces of a network slice based on at least one condition related to the network slice, wherein application of the congestion control process addresses the at least one condition related to the network slice; and
applying the congestion control process in a protocol stack for the plurality of interfaces of the network slice.

17. The network node of claim 16 adapted to perform operations of obtaining a recommendation from a network node for a congestion control process for a plurality of interfaces of a network slice based on at least one condition related to the network slice, wherein application of the congestion control process addresses the at least one condition related to the network slice; and
applying the congestion control process in a protocol stack for the plurality of interfaces of the network slice,
wherein the network node comprises at least one of a cognitive layer and a machine learning model, and wherein the machine learning model comprises an unsupervised machine learning model.

18. A computer program comprising program code to be executed by processing circuitry of a network node, whereby execution of the program code causes the network node to perform operations comprising:
obtaining a recommendation from the network node for a congestion control process for a plurality of interfaces of a network slice based on at least one condition related to the network slice, wherein application of the congestion control process addresses the at least one condition related to the network slice; and
applying the congestion control process in a protocol stack for the plurality of interfaces of the network slice.

19. The computer program of claim 18, whereby execution of the program code causes the network node to perform of obtaining a recommendation from a network node for a congestion control process for a plurality of interfaces of a network slice based on at least one condition related to the network slice, wherein application of the congestion control process addresses the at least one condition related to the network slice; and
applying the congestion control process in a protocol stack for the plurality of interfaces of the network slice,
wherein the network node comprises at least one of a cognitive layer and a machine learning model, and wherein the machine learning model comprises an unsupervised machine learning model.

20. A computer program product comprising a non-transitory storage medium including program code to be executed by processing circuitry of a network node, whereby execution of the program code causes the network node to perform operations comprising:
obtaining a recommendation from the network node for a congestion control process for a plurality of interfaces of a network slice based on at least one condition related to the network slice, wherein application of the congestion control process addresses the at least one condition related to the network slice; and
applying the congestion control process in a protocol stack for the plurality of interfaces of the network slice.

21. (canceled)
